(19) United States
(12) Patent Application Publication
(10) Pub. No.: US 2025/0066932 A1
(43) Pub. Date: Feb. 27, 2025

(54) A FUNCTIONAL PV POWERED FACILITATED WATER ELECTROLYZER SYSTEM FOR SOLAR HYDROGEN GENERATION AND PROCESSES THEREOF

(71) Applicant: COUNCIL OF SCIENTIFIC AND INDUSTRIAL RESEARCH (AN INDIAN REGISTERED BODY INCORPORATED UNDER THE, Delhi (IN)

(72) Inventors: Sadhana SURESH RAYALU, Nagpur (IN); Shilpa KUMARI, Nagpur (IN); Sehba ANSARI, Nagpur (IN); Meenal WAHANE, Nagpur (IN); Kushagra GABHANE, Nagpur (IN); Neha SINGH, Nagpur (IN); Sayali SHIRPURKAR, Nagpur (IN); Aparna VAIDYA, Nagpur (IN)

(21) Appl. No.: 18/726,252

(22) PCT Filed: Mar. 21, 2023
(86) PCT No.: PCT/IN2023/050276

§ 371 Date: Jul. 2, 2024

(30) Foreign Application Priority Data
Mar. 23, 2022 (IN) 202211016562

(51) Int. Cl. C25B 9/50; C25B 1/04; C25B 1/26; C25B 11/046; C25B 11/063; C25B 11/081

(52) U.S. Cl. CPC C25B 9/50; C25B 1/04; C25B 1/26; C25B 11/046; C25B 11/063; C25B 11/081

(57) ABSTRACT

The present disclosure provides a functional (photovoltaic) PV powered facilitated Water electrolyzer system for solar hydrogen generation having two components: a functional PV panel and a facilitated water electrolyzer. The present invention provides functional PV powered facilitated water electrolyzer (F-PV-WE) systems. The invention provides a process using integrated functional PV with facilitated water electrolysis for multiproduct generation including hydrogen, oxygen and hypochlorite with reduction in energy and environmental footprint.

### FIELD OF INVENTION

The present invention provides a functional (photovoltaic) PV powered facilitated Water electrolyzer system for solar hydrogen generation. Particularly, the present invention provides a functional PV powered water electrolyzer system having two components including a Functional PV panel and Facilitated water electrolyzer. More particularly, the present invention provides functional PV powered facilitated Water electrolyzer (F-PV-WE) systems. Further the present invention provides a process using integrated PV with mature technology of facilitated water electrolysis for multiproduct generation including hydrogen, oxygen and hypochlorite with reduction in energy and environmental footprint.

### BACKGROUND OF INVENTION

Development of cost-efficient, robust, scalable, without carbon dioxide (CO₂) emission as an alternate energy for non-renewable energy source is one of the barriers for large-scale penetration of PEMFC in India such as lack of hydrogen infrastructure.

Solar fuels can be generated in three ways including (1) PV based systems for conversion of solar energy into electricity, which in turn, drives water electrolysis to split water into hydrogen and oxygen; (2) design of PEC or photocatalytic systems wherein water splitting reactions are driven directly by light, without the need to separately generate electricity; and (3) photothermal systems to provide heat that induces water splitting in presence of a redox substrate like ceria, or to provide heat and photons to a mixture of water and donor to facilitate photothermal reforming of donor or chemical reactions such as oxidative hydrolysis of zinc etc.

U.S. Pat. No. 7,674,358B2 discloses a method for configuring a solar hydrogen generation system and the system optimization are disclosed. The system utilizes photovoltaic modules and an electrolyte solution to efficiently split water into hydrogen and oxygen.

U.S. Pat. No. 7,241,950B2 uses a water permeable electrode for electrochemical splitting of water having a light sensitive catalytic material layer, a polymer electrolyte membrane layer, a metallic substrate layer disposed there between, directly adjacent to the polymer electrolyte membrane layer, and at least one photovoltaic device connected in series to the light sensitive catalytic material layer and disposed between the light sensitive catalytic material layer and the metallic substrate layer.

Reference may be made to the U.S. Pat. No. 7,645,930B2. The embodiment of the invention includes a process comprising transmitting electrical power produced by a PV array to an electrolyzer and transferring heat from the PV array to the electrolyzer. The resulting process produces renewable hydrogen from solar energy at a lower cost per kg.

CN205046202U discloses a solar photovoltaic water electrolysis hydrogen's device, including solar photovoltaic board subassembly, solar control ware, solar battery, rectification pressure regulating circuit, brine electrolysis device, hydrogen plant.

Reference may be made to another patent 201717005199 which claimed the use of electrode that has a titanium substrate an inner catalytic coating containing oxides of tantalum ruthenium and iridium and an outer catalytic coating containing oxides of titanium ruthenium and of at least one of nickel, iron and cobalt for electrolytic treatments of dilute solutions of sodium chloride.

Reference may be made to patent 201917033891 which claimed the use of electrodes made up of one or more metals with the anodes coated with platinum and/or an oxide or oxides of one or more of iridium, ruthenium, tin, rhodium, or tantalum (optionally alloyed with antimony and/or manganese) and cathodes coated with platinum and/or an oxide or oxides of one or more of iridium, ruthenium, and titanium.

Reference may be made to U.S. Pat. No. 7,931,795-B2 which relates to a novel economical on-site electrochemical based membrane cell based process with the capability of producing high strength sodium hypochlorite and/or elemental chlorine gas in any ratio as required by the needs of a water or wastewater treatment plant. The system uses membrane cell based electrolyzers and utilizes novel process modifications and sensors to allow for the unattended control and safe operation of the process.

Nasser Abu Ghalwa et. al. (Arabian Journal of Chemistry (2011), doi:10.1016/j.arabjc.2011.08.006) used two modified electrodes (Pb/PbO₂ and C/PbO₂), prepared by electrodepositing a lead oxide layer on lead and carbon substrates. The maximum concentration of NaOCl of about 2% was achieved using NaCl solution (20 g/L) at a temperature of 10° C., electrolysis time of 60 minutes, current density of 1 A/cm² and a solution of pH equal to 12.

S. Yu. Bashtan et. al. (Desalination 126, (1999) 77-82) investigated the electrochemical synthesis of NaOCl in a membrane electrolyzer using an alumina-zirconia ceramic membrane with a titanium anode coated with cobalt oxide. The overall optimal conditions for the installation were found to be the following: current density of 60 mA/cm² and NaCl concentration of 25 g/L. Under these conditions the consumption of NaCl was found to be 2.4 Kg/Kg of NaOCl with a current efficiency of 77%.

L. N. Fesenko et. al. (Solid State Phenomena Submitted: 2018 Jul. 2 ISSN: 1662-9779, Vol. 284, pp 807-813) developed a technology of producing NaOCl from the concentrate of reverse osmosis systems. The concentrate containing predominantly divalent Ca²⁺, Mg²⁺ and SO₄²⁻ ions was subjected to reagent treatment in the following sequence: first stage with barium compounds and second stage with carbonate and sodium hydroxide.

A. Kraft et. al. (Journal of Applied Electrochemistry 29: 861-868, 1999) studied the electrolytic production of hypochlorite in very dilute chloride solutions using platinum and iridium oxide coated titanium expanded metal electrodes as anodes. The active chlorine production rate on IrO₂ was found to be higher than that on platinum.

Husam D. Al-Hamaiedeh (Desalination and Water Treatment, 51:16-18, 3521-3526, DOI: 10.1080/19443994.2012.749576) used brine derived from the Dead Sea (salinity value of about 30%) as a chloride source in the electrochemical production of active chlorine (AC) compounds.

Vishwa Bhatt et. al. (Journal of Energy Chemistry (2016), doi: 10.1016/j.jechem.2016.09.006) introduced a theoretical framework to model silicon based integrated PV-EC device. The theoretical framework is used to analyze the coupling and kinetic losses of a silicon solar cell based integrated PV-EC water splitting system under varying temperature and illumination.

Sang Youn Chae et. al. (Solar Energy, Volume 135, October 2016, pages 821-826) assessed a tandem solar cell equipped with a dye-sensitized solar cell (DSSC) and a CuInxGaIxSySeIy (CIGS) bottom sub-cell, for photovoltaic cell (PV)-assisted water splitting application. Two types of cobalt complexes ([Co(bpy)3]2+/3+ and [Co(phen)3]2+/3+) were tested as the redox couples in the DSSC sub-cell.

Monika Gupta et. al. (Advanced Materials Research Vol. 67 (2009) pp 95-102) deals with a study on 120 MeV Ag9+ irradiated thin films of zinc oxide (ZnO), obtained by sol-gel—spin coating onto TCO glass plates. Films irradiated at fluence 5×1011, 3×1012, 5×1012 and 2×1013 ions cm−2, were optically characterized for band gap determination.

S. M. Ho et. al. (Asian Journal of Chemistry; Vol. 31, No. 1 (2019), 18-24) showed a brief overview of photoelectrochemical hydrogen production, progress and ongoing sprints. Here, different metal chalcogenides were deposited on metal oxides (TiO2 and Fe2O3) in order to improve the photoelectrochemical performance by reducing recombination of photogenerated electron-hole pairs and facilitate hole transport at the metal chalcogenides/metal oxides/electrolyte interface.

Cunping Huang (Solar Energy, 91 (2013) 394-401, http://dx.doi.org/10.1016/j.solener.2012.09.009) studied solar hydrogen production via direct current pulse electrochemical oxidation of aqueous ammonium sulfite solutions, one important step in solar sulfur-ammonia (S-NH3) thermochemical water splitting cycles.

Yosuke Kageshima et. al. (Scientific Reports, 6:24633, DOI:: 10.1038/srep24633) studied a novel “photovoltaics (PV)+electrolyzer” concept using a simple, small, and completely stand-alone non-biased device for solar-driven overall water splitting.

Xiaofei Zhang et. al. (Nano Energy, Volume 48, June 2018, Pages 481-488) studied high performance carbon nanoparticles for light harvesting that have been synthesized via a facile and efficient method. By the in-situ coating of the nanoparticles on a commercial thermoelectric generator, a high-efficient solar thermoelectric generator (STEG) was constructed.

K. A. Walczak et. al. (Adv. Energy Mater. 2017, 1602791, DOI: 10.1002/aenm.201602791) studied safe and practical solar-driven hydrogen generators that must be capable of efficient and stable operation under diurnal cycling with full separation of gaseous H₂ and O₂ products. In this study, a novel architecture that fulfils all of these requirements is presented.

Hongsheng Wang et. al. (Energy Conversion and Management, Volume 210, 15 Apr. 2020, 112699) proposed a novel hydrogen production system by combining PV cell and photon-enhanced thermionic emission cell (PETE) with the solid oxide electrolysis cell (SOEC).

From the above literature, it could be concluded that there is a need for generation of hydrogen using functional PV panel and facilitated water electrolyser.

In recent decades there is a huge demand to enhance the power generation due to continuously increasing consumption of electrical energy. In order to achieve this, renewable energy sources are the best options. The solar energy is the best alternative to the existing technologies for production of electrical energy. There is a need to enhance the overall performance of the PV panel since the efficiency of the PV-panel get affected by various parameters such as UV radiations, dust, dirt, excessive heat and temperature.

### OBJECTIVES OF THE INVENTION

The main objective of the invention is to provide functional PV powered facilitated Water electrolyzer (F-PV-WE) system for solar hydrogen generation including two components functional PV panel and facilitated water electrolyser.

Another objective of this invention is to replace the conventional PV panel with Functional PV panel retrofitted with peltier device having V-trough concentrator coupled with solar PV panel for hydrogen generation.

Yet another objective is to develop facilitated water electrolyzer thus addressing an important issue of lack of hydrogen infrastructure by providing cost-efficient, robust, scalable, with minimal carbon dioxide (CO₂) emission, alternate renewable energy source for large-scale penetration of PEMFC.

Yet another objective is to develop cost-efficient, robust, scalable, with minimal carbon dioxide (CO₂) emission PV powered facilitated Water electrolyzer system for hypochlorite mixed oxide disinfectant.

Yet another objective of this invention is to develop a facilitated electro-chlorination system wherein the electricity required for the conventional electro-chlorination system is reduced by using inorganic donor (sacrificial and non-sacrificial).

Yet another objective is to integrate/unify PV with facilitated water electrolysis for multiproduct generation including hydrogen, oxygen and hypochlorite with reduction in energy and environmental footprint.

### SUMMARY OF INVENTION

In an embodiment of the present invention, there is provided a functional PV power facilitated water electrolyzer system for solar hydrogen generation and method for generation thereof, wherein the said system comprises:
i. Functional Solar PV Panel (2)
ii. Facilitated Water Electrolyzer (3)

In an embodiment of present invention, the functional solar PV panel (2) is made of reflectors (1) and heat harvesting system with hydrophobic coating on the Panel with enhanced efficiency of 6-8% over commercial panel.

In another embodiment of present invention, the said system includes standalone and integrated system with non-sacrificial electrodes with or without sacrificial anode with enhancement efficiency by a factor of 1.2-1.5 for hydrogen evolution reaction (HER) and reduced footprint.

In yet another embodiment of present invention, the electrolysis chamber of the functional PV (85 cm×80 cm×12 cm) powered facilitated water electrolyzer system (42 cm×55 cm×6 cm) is retrofitted with photo-illumination effect through tungsten bulb using two anodic plates of titanium electrode coated with mixed metal oxide and three uncoated cathodic plates water electrolysis to generate hydrogen generation at the cathode, oxygen at the anode and hypochlorite in the solution and the system is standalone and comprises of the following components,
i. Reflectors (1) (85 cm×80 cm) retrofitted to solar PV panel with the photonic wavelength to enhance the electric output of PV panel,
ii. Functional Solar PV Panel (2) (85 cm×80 cm) with increased electrical output to operate the facilitated water electrolyzer,
iii. Facilitated Water Electrolyzer (3) (42 cm×55 cm×6 cm) with enhanced water electrolysis rate, and comprises components (4-12),
iv. Solution inlet (4) with tungsten lamp fixed inside the chamber (2 cm diameter) is to introduce the electrolytic solution inside the chamber whereas the retrofitted tungsten lamp is for photo-illumination effect,
v. Solution level Indicator (5) 4 cm×3.5 cm to check the solution level inside the electrolysis chamber to ensure the dipping of Ti electrode,
vi. Reactor chamber (6) 23 cm×30 cm×22 cm to carry out PV-based water electrolysis reaction inside the chamber,
vii. Hydrogen Outlet (7) of 3 cm diameter to collect the hydrogen gas.
viii. Ti Electrode (8) made of Mixed metal oxide coated with surface area of 300 cm² and provides surface for redox reactions at cathode and anode for hydrogen and oxygen evolution reactions,
ix. On/Off Switch (9) 2 cm×4.5 cm to start/stop the water electrolysis reaction,
x. Cooling fan (10) 13 cm×13 cm to maintain the temperature of electric circuit,
xi. Voltmeter (11) is 7 cm×7 cm for display the DC voltage supplied for water electrolysis,
xii. Ammeter (12) is 7 cm×7 cm for display of DC current supplied for water electrolysis,
xiii. Facilitated water electrolyzer (3) with electrolytic solution and retrofitted with photo-illumination effect through tungsten bulb using two plates of titanium electrode coated with mixed metal oxide water electrolysis to generate hydrogen generation at the cathode, oxygen at the anode and hypochlorite in the solution and the said system also comprises components 1-12 is connected to functional PV Panel (85 cm×80 cm×12 cm).

In still another embodiment of present invention, the facilitated water electrolyzer of dimension 85 cm×80 cm×12 cm is retrofitted behind the functional PV panel (85 cm×80 cm×12 cm) for integrated and compact system having electrolytic solution and two plates of titanium electrode coated with mixed metal oxide water electrolysis to generate hydrogen generation at the cathode, oxygen at the anode and hypochlorite in the solution and the said system also comprises components (1), (2), (4), (5), (7), (8), (9), (11) and (12).

In yet another embodiment, the present invention, there is provided a method comprises the steps of:
i. preparing sacrificial & non-sacrificial electrolytic solutions as donors wherein the said electro-catalytic solution is having pH in the range of 5.0-6.0, 7.0-7.2 and 9.0-12.0,
ii. filling the electrolytic solutions obtained of step (i) in facilitated water electrolyzer up to 8 L/12 L reactor volume,
iii. connecting the electrodes to terminals (positive and negative) of the voltage regulator and applying a voltage in the range of 3 to 4 Volts at temperature in the range of 32 to 36° C. with or without illumination to produce hydrogen (2-42 lph), oxygen (0-12.6 lph) and sodium hypochlorite (stable range of 0-13%) is produced as a by-product.

In still another embodiment of present invention, the donor is selected from NaCl, hydrogen peroxide, 3% NaCl+1% H₂O₂, potassium permanganate (KMnO₄), sodium sulphide, sodium borohydride (NaBH₄), heteropoly acids, ethanol, urea, or combinations thereof.

In yet another embodiment of present invention, the sacrificial and non-sacrificial electrodes (anodes and cathodes) are selected from titanium, aluminium, steel, Nickel electrodes with and without mixed metal oxide coating.

In yet another embodiment of present invention, the non-sacrificial electrodes are titanium electrodes with mixed metal oxide coating Ruthenium and Iridium salt and the sacrificial electrodes are aluminium electrodes (anode) and non-sacrificial electrode is titanium (cathode) electrodes with mixed metal oxide coating and wherein the surface area of the said electrode was 360 cm².

In further embodiment of present invention, the said method generates hydrogen with electrolyte volume of 1 litre to 25 litre is about (2-42 lph), oxygen (0-12.6 lph) and sodium hypochlorite (stable range of 0-13%) using non sacrificial Ti mixed metal coated electrodes, 0-3% NaCl and 0-1% H₂O₂ as donor; sacrificial anode (steel) & non sacrificial Ti mixed metal coated cathode using 0-3% NaCl as donor and sacrificial anode (aluminium) and non-sacrificial Ti mixed metal coated cathode using Na₂S as donor, the variation in the volume of the electrolyte to volume of the reactor is between 8-12 L to 35-40 L wherein on illumination hydrogen evolution rate (HER) enhances by a factor 1.5-2.0 with all other conditions and parametric ranges remaining the same.

These and other features, aspects, and advantages of the present subject matter will be better understood with reference to the following description and appended claims. This summary is provided to introduce a selection of concepts in a simplified form. This summary is not intended to identify key features or essential features of the claimed subject matter, nor is it intended to be used to limit the scope of the claimed subject matter.

### BRIEF DESCRIPTION OF DRAWINGS

The following drawings form a part of the present specification and are included to further illustrate aspects of the present disclosure. The disclosure may be better understood by reference to the drawings in combination with the detailed description of the specific embodiments presented herein.

FIG. 1 provides flow chart of solar hydrogen production, in accordance with an embodiment of the present disclosure.

FIG. 2 provides flow diagram depicting standalone systems for solar hydrogen production using (i) functional PV panel also designated as broad band absorption cell by virtue of the fact that UV and IR photons are being absorbed in addition to absorption of visible photons; and (ii) facilitated water electrolyzer for donor assisted water Electrolysis, in accordance with an embodiment of the present disclosure.

FIG. 3 shows standalone compact system with Reflectors (1), Functional Solar PV Panel (2), Facilitated Water Electrolyzer (3) for solar hydrogen production, in accordance with an embodiment of the present disclosure.

FIG. 4 depicts Functional PV panels with functional coating, heat harvesting device and reflectors, in accordance with an embodiment of the present disclosure.

FIG. 5 shows Facilitated water electrolyzer housing with Solution inlet (4), Solution level Indicator (5), Reactor chamber (6), Hydrogen Outlet (7), Electrode (8), On/Off Switch (9), Cooling fan (10), Voltmeter (11), Ammeter (12), in accordance with an embodiment of the present disclosure.

FIG. 6 shows integrated system for Solar Hydrogen Production using functional PV panel retrofitted with facilitated water electrolyzer (13), in accordance with an embodiment of the present disclosure.

### DETAILED DESCRIPTION OF THE INVENTION

Those skilled in the art will be aware that the present disclosure is subject to variations and modifications other than those specifically described. It is to be understood that the present disclosure includes all such variations and modifications. The disclosure also includes all such steps, features, compositions, and compounds referred to or indicated in this specification, individually or collectively, and any and all combinations of any or more of such steps or features.

### Definitions

For convenience, before further description of the present disclosure, certain terms employed in the specification, and examples are delineated here. These definitions should be read in the light of the remainder of the disclosure and understood as by a person of skill in the art. The terms used herein have the meanings recognized and known to those of skill in the art, however, for convenience and completeness, particular terms and their meanings are set forth below.

The invention has other advantages and features which will be more readily apparent from the following detailed description of the invention, when taken in conjunction with the accompanying drawings, in which:

While the invention has been disclosed with reference to certain embodiments, it will be understood by those skilled in the art that various changes may be made, and equivalents may be substituted without departing from the scope of the invention. In addition, many modifications may be made to adapt to a particular situation or material to the teachings of the invention without departing from its scope.

Throughout the specification and claims, the following terms take the meanings explicitly associated herein unless the context clearly dictates otherwise. The meaning of “a”, “an”, and “the” include plural references. The meaning of “in” includes “in” and “on.” Referring to the drawings, like numbers indicate parts throughout the view. Additionally, a reference to the singular includes a reference to the plural unless otherwise stated or inconsistent with the disclosure herein.

The tables, figures and protocols have been represented where appropriate by conventional representations in the drawings, showing only those specific details that are pertinent to understanding the embodiments of the present invention so as not to obscure the disclosure with details that will be readily apparent to those of ordinary skill in the art having benefit of the description herein.

In order to address the huge demand to enhance the power generation, renewable energy sources are the best options. The solar energy is the best alternative to the existing technologies for production of electrical energy. There is a need to enhance the overall performance of the PV panel since the efficiency of the PV-panel get affected by various parameters such as UV radiations, dust, dirt, excessive heat and temperature. By using peltier device, the overall performance of the PV-panel could be enhanced up to certain extent by harvesting excess heat thereby increasing the electrical power output. The conventional PV panel can be replaced by functional PV panel.

Accordingly, to accomplish the objectives of the invention, the present invention relates to an eco-friendly functional PV powered facilitated Water electrolyzer system for solar hydrogen with concomitant oxygen cum hypochlorite generation with reduced energy and environmental footprint compared to the commercial water electrolyzer/or its counterpart. Specifically, this invention focusses on enhanced performance of solar panels and reduction of electricity consumption with the usage of donors and photo-illumination for consequent benefit of low cost and reduced emissions.

In an embodiment of the present invention, there is provided a functional PV powered facilitated water electrolyzer system for solar hydrogen generation and method for generation thereof wherein the said system comprises; Functional Solar PV Panel (2) and Facilitated Water Electrolyzer (3).

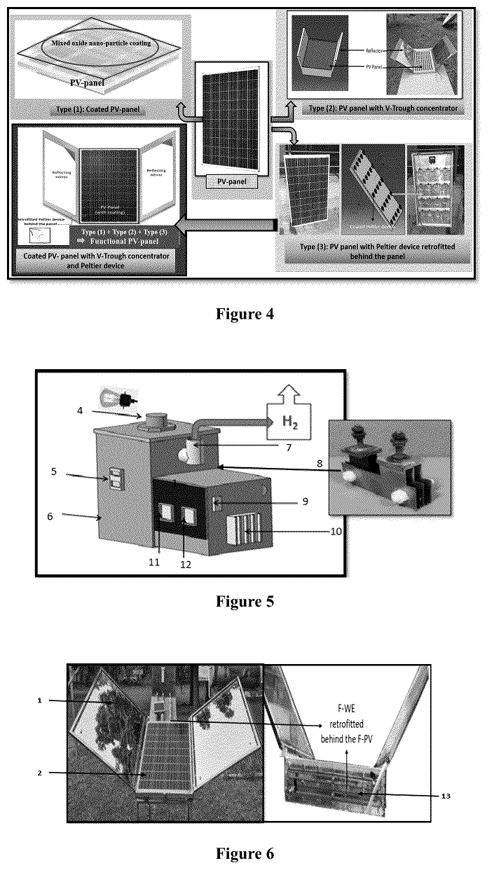

In an embodiment of the present invention, the functional solar PV panel (2) is made of reflectors (1) and heat harvesting system with hydrophobic coating on the Panel with enhanced efficiency of 6-8% over commercial panel, the said system includes standalone and integrated system with non-sacrificial electrodes with or without sacrificial anode with enhancement efficiency by a factor of 1.2-1.5 for hydrogen evolution reaction (HER) and reduced footprint. FIG. 3 represents the complete Functional PV powered facilitated Water electrolyzer system for solar hydrogen generation having two components, a Functional PV panel (2, FIG. 4) and Facilitated water electrolyzer (3, FIG. 5). FIG. 4 represents the detailed structure of the functional PV panel, in which the mixed oxide nano-particle coating is applied on the PV panel with V-trough glass reflectors 1 for efficiency enhancement by way of increased reflection leading to increased path length of photons and generation of heat and retrofitted peltier device fixed behind the PV-panel. Type 1 with hydrophobic coating to prevent deposition of aerosol and particulate, Type 2 with V-trough concentrator for concentrating photons and heat and enhancing efficiency by about 10-12%, Type 3 Peltier device for harvesting heat and enhancing efficiency by about 10-12%, Type 4 is all in one with hydrophobic coating, V-trough concentrator and Peltier device with enhanced efficiency of 20-24% and increased shelf life. The energy output i.e., electricity generated from the functional PV panel is then supplied to the facilitated water electrolyzer as shown in FIG. 5, for hydrogen generation. FIG. 5 stands for the facilitated water electrolyzer (made using fiber reinforced plastic material) in which the electrolytic solution is filled from the solution inlet retrofitted with photo-illumination effect of tungsten bulb 4, solution level indicator 5 is used to confirm the solution level inside the electrolysis chamber 6 to ensure the Ti electrode 8 dipping inside the electrolyte solution. Ti Electrode (Mixed metal oxide coated) which is used for PV based electrolysis in which 3 plates are of uncoated (blank) titanium electrode and the remaining two plates are coated with mixed metal oxide coating. The power supply unit comprises of the on/off switch 9, cooling fan 10, voltmeter 11 and ammeter 12 which is used to supply DC electricity to activate water electrolysis for hydrogen generation. The generated hydrogen gas is then collected via hydrogen outlet 7. FIG. 6 represents integrated system for solar Hydrogen generation using functional PV panel integrated with facilitated water electrolyzer 13 for water Electrolysis as single compact system.

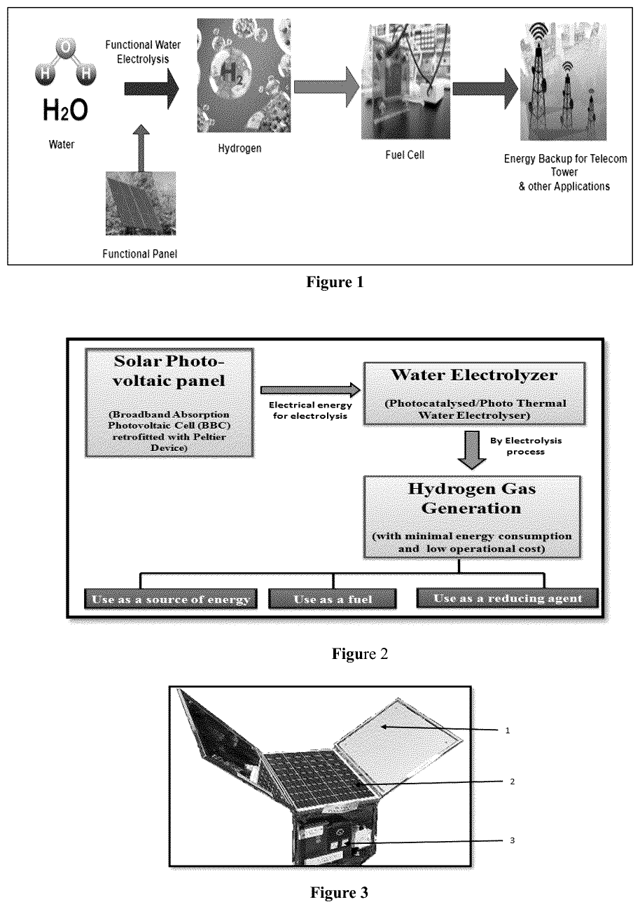

In an embodiment of the present invention, there is provided a functional PV powered standalone facilitated water electrolyzer system for solar hydrogen generation and method for generation thereof comprising the following as per FIG. 1 to FIG. 6 with detailed dimensions.
i. Reflectors (1) (85 cm×80 cm) retrofitted to solar PV panel with the photonic wavelength to enhance the electric output of PV panel,
ii. Functional Solar PV Panel (2) (85 cm×80 cm) with increased electrical output to operate the facilitated water electrolyzer,
iii. Facilitated Water Electrolyzer (3) (42 cm×55 cm×6 cm) with enhanced water electrolysis rate, and comprises components (4-12),
iv. Solution inlet (4) with tungsten lamp fixed inside the chamber (2 cm diameter) is to introduce the electrolytic solution inside the chamber whereas the retrofitted tungsten lamp is for photo-illumination effect,
v. Solution level Indicator (5) 4 cm×3.5 cm to check the solution level inside the electrolysis chamber to ensure the dipping of Ti electrode,
vi. Reactor chamber (6) 23 cm×30 cm×22 cm to carry out PV-based water electrolysis reaction inside the chamber,
vii. Hydrogen Outlet (7) of 3 cm diameter to collect the hydrogen gas.
viii. Ti Electrode (8) made of Mixed metal oxide coated with surface area of 300 cm² and provides surface for redox reactions at cathode and anode for hydrogen and oxygen evolution reactions,
ix. On/Off Switch (9) 2 cm×4.5 cm to start/stop the water electrolysis reaction,
x. Cooling fan (10) 13 cm×13 cm to maintain the temperature of electric circuit,
xi. Voltmeter (11) is 7 cm×7 cm for display the DC voltage supplied for water electrolysis,
xii. Ammeter (12) is 7 cm×7 cm for display of DC current supplied for water electrolysis,
xiii. Facilitated water electrolyzer (3) with electrolytic solution and retrofitted with photo-illumination effect through tungsten bulb using two plates of titanium electrode coated with mixed metal oxide water electrolysis to generate hydrogen generation at the cathode, oxygen at the anode and hypochlorite in the solution and the said system also comprises components i-xii is connected to functional PV Panel (85 cm×80 cm×12 cm).

In an embodiment of the present invention, there is provided a functional PV powered facilitated Water electrolyzer system for solar hydrogen generation, wherein the facilitated water electrolyzer of dimension 85 cm×80 cm×12 cm is retrofitted behind the functional PV panel (85 cm×80 cm×12 cm) for integrated and compact system having electrolytic solution and two plates of titanium electrode coated with mixed metal oxide water electrolysis to generate hydrogen generation at the cathode, oxygen at the anode and hypochlorite in the solution and the said system also comprises components (1), (2), (4), (5), (7), (8), (9), (11) and (12).

In an embodiment of the present invention, there is provided a functional PV powered facilitated Water electrolyzer system for solar hydrogen generation, wherein the donor is selected from NaCl, 3% NaCl, hydrogen peroxide, 3% NaCl+1% H₂O₂, Potassium Permanganate (KMnO₄), Sodium sulphide, Sodium Borohydride (NaBH₄), heteropoly acids, ethanol, urea or combinations thereof; and the sacrificial and non-sacrificial electrodes (anodes and cathodes) are selected from titanium, aluminium, steel and nickel electrodes with and without mixed metal oxide coating.

The present disclosure provides a functional PV powered facilitated Water electrolyzer system which is developed on the basis of the following:

i) Developing Facilitated Water Electrolyzer with Reduced Energy and Environmental Footprint
Facilitated water electrolyzer with reduced electricity consumption using organic & inorganic donors for multiproduct generation including hydrogen, oxygen and mixed oxide disinfectant.
Facilitate water electrolyzer with reduced electricity consumption using organic & inorganic donor for solar hydrogen and hypochlorite generation with minimal oxygen generation.
Facilitated water electrolyzer with reduced electricity consumption using organic & inorganic donor for solar oxygen and hypochlorite generation with minimal hydrogen generation.

### ii) Developing Functional PV Panel for Harnessing UV, IR Light and Heat Singly or in Combination

The present invention provides: a) functional PV panel with enhanced efficiency and b) new class of donor based facilitated water electrolyzer which reduces electricity consumption with donors which have dual function and properties of reducing electricity and residual/unreacted donor function as disinfectant. The electricity requirement is reduced significantly thus addressing the explicit aim to reduce electricity consumption. These systems showed enhanced performance in solar to hydrogen conversion efficiency as compared with their counterpart commercially available in the market.

The following criteria have been taken into consideration for usage of donors:
Safety, affordability, ready availability and practicability
Non-toxicity
Pollution neutral
Potential for reducing electricity consumption
Potential for generation of hydrogen and oxygen

This invention deals in specific with environment-friendly integration of functional PV panel for powering facilitated water electrolyzer. The process flow diagram is shown in FIG. 2.

The present invention discloses use of BBC (Broadband Absorption Photovoltaic Cell) for enhancement of electrical efficiency and use of a hybrid, modular, portable and transformative broadband absorption photovoltaic cell (BBC) based photocatalyzed water electrolyzer for delivering hydrogen gas. Augmentation of water electrolysis process with innovations including illumination, photocatalysis and plasmonics, usage of donors like sodium chloride, sodium hypochlorite, HPA/HPB, sodium sulphide for splitting water is disclosed herein. Generation of redox shuttle for coupling with water electrolyzer that reduces the energy requirements and use of functional PV panels by harvesting heat through Peltier device and nano fluids is also provided.

Although the subject matter has been described in considerable detail with reference to certain embodiments thereof, other embodiments are possible. As such, the spirit and scope of the disclosure should not be limited to the description of the embodiments contained herein.

### EXAMPLES

The following examples are given by way of illustration and therefore should not be construed to limit the scope of the present invention.

### Example 1

The present invention provides a functional PV power facilitated water electrolyzer system for solar hydrogen generation and method for generation thereof, wherein the said system comprises; (i) Functional Solar PV Panel (2); (ii) Facilitated Water Electrolyzer (3).

The said system included standalone and integrated system with non-sacrificial electrodes with or without sacrificial anode with enhancement efficiency by a factor of 1.2-1.5 for hydrogen evolution reaction (HER) and reduced footprint.

The electrolysis chamber of the functional PV (85 cm×80 cm×12 cm) powered facilitated water electrolyzer system (42 cm×55 cm×6 cm) was retrofitted with photo-illumination effect through tungsten bulb using two anodic plates of titanium electrode coated with mixed metal oxide and three uncoated cathodic plates water electrolysis to generate hydrogen generation at the cathode, oxygen at the anode and hypochlorite in the solution and the system was standalone and comprising of the components 1-12, mentioned in the summary of the invention.

Different system of facilitated water electrolyzer & functional PV panel is illustrated below as:

### A) Design of Facilitated Water Electrolyzer for Generation of Multi-Products (Hydrogen, Oxygen and Disinfectant): The Details of the System are as Follows:

i) Sacrificial donor assisted water electrolysis with and without illumination.
ii) Usage of photo-catalytically generated non-sacrificial redox shuttle like HPA/HPB to reduce electricity requirement in water electrolyzer with and without illumination.
iii) Plasmonic heating for improved water splitting with and without illumination.

Facilitated Water Electrolyzer for Hydrogen Generation with concomitant oxygen cum hypochlorite generation.
Conditions for Solar Hydrogen, Oxygen (minimal) and mixed oxide disinfectant generation (FIG. 3).
   It was observed that hydrogen rich gas was generated by the electrolysis of NaCl+H₂O₂ solution when higher voltage was applied across the electrodes, along with the formation of mixed oxide disinfectant.
Conditions for Solar Hydrogen (minimal), Oxygen and mixed oxide disinfectant generation)
   It was observed that oxygen rich gas was generated by the electrolysis of NaCl+H₂O₂ solution when lower voltage was applied across the electrodes, along with the formation of mixed oxide disinfectant.

The system was designed to generate solar hydrogen and oxygen using facilitated water electrolyzer coupled with PV panel.

The system was helpful in generation of solar hydrogen with concomitant oxygen generation and liquid based disinfectant i.e., hypochlorite based mixed oxidant solution. The invention provided a practical, non-polluting technology for producing hydrogen that can be used as a fuel for various applications.

The system involved use of donor-assisted water electrolysis system for generation of hydrogen. The process involved use of brine solution in combination with peroxide as the electrolytic solution along with the use of Mixed Metal Oxide coated Titanium electrodes.

DC current was supplied to the Mixed Metal Oxide coated Titanium electrodes and the hydrogen and oxygen generated were analyzed using Thermal Conductivity Detector (TCD) where Nitrogen was used as the carrier gas. Performance of facilitated water electrolyzer for hydrogen generation along with concomitant oxygen & hypochlorite generation with the functionality of different donors varied.

Hydrogen was produced by the electrolysis of brine (a solution of sodium chloride) in a fully mixed cell. A direct current was passed through a solution of sodium chloride (common salt) containing Na⁺ and Cl⁻, producing chlorine at the anode, and hydrogen at the cathode. In the present invention, a combination of 1-5% hydrogen peroxide and 1-5% NaCl was used for arriving at optimal conditions to produce solar hydrogen enriched gas and hypochlorite or solar oxygen enriched gas and hypochlorite.

Hydrogen generation using ethanol as a donor, an alcohol-based electrolysis system for hydrogen generation was studied using ethanol (C₂H₅OH). Ethanol when used in alkaline medium (1 N NaOH solution) was also found to generate hydrogen at comparatively higher generation rate.

HPA (Heteropoly acid) or electron coupled proton buffer (ECPB) based shuttle was studied for the generation of hydrogen. Heteropoly acid (HPA) had strong proton conducting ability and redox property. HPA could accommodate the excess electrons owing to their high oxidizability. Reduced system of mixed valance (+5, +6) possessed a deep blue color which justifies its name of heteropolyblue (HPB). HPB served as an e rich centre and acted as antenna molecules for harvesting visible light and proton storage which can release hydrogen at reduction sites. Hydrogen was generated using HPA/HPB shuttle in acidic conditions at comparatively higher generation rate.

### B) Design of Functional PV Panel:

The functional PV panel has the following modifications:
i) Solar PV panel with peltier module;
ii) V-trough concentrator coupled with solar PV panel;
iii) Hydrophobic coating to prevent dust.
   a) Peltier module (thermoelectric device): a device that consisting of a p-type and n-type semiconductors. This structure could be used to convert heat energy to electricity by using a principle known as the Seebeck effect. A thermoelectric (TE) power generation occurred when a voltage was generated from a temperature difference across two different semiconductor materials.

The solar and peltier energy obtained was stored to a battery. By hybrid which increased cell life, improve performance, and provided operational benefits under different environmental conditions. A peltier device with water jacket was used to harvest heat of PV-panel which was then used to heat the water. Heated water could be used for different application.

b) V-Trough Concentrator Coupled with Solar PV Panel

The conventional PV panel was retrofitted with two reflecting surfaces on two of its parallel sides. The reflecting surfaces were placed at an angle such that the incident solar radiations were reflected and uniformly distributed at the panel surface which in turn increased the output power thereby increasing the efficiency of panel. Experiments were performed with the experimental setup given below and the data were summarized in the table given in the output section of this table. It was observed that approximately 10% enhancement in electrical efficiency of a 10 W PV-panel. The schematic representation of the system is given in FIG. 4.

### C) Facilitated Donor Assisted Electro-Chlorination Process

The system was customized for the generation of hypochlorite based mixed oxidant solution for use as a disinfectant.

Sodium hypochlorite was produced by the electrolysis of brine (a solution of sodium chloride). Electro-chlorination produced a weak hypochlorite (<10 g/l) solution that was easy to handle and avoided many of the safety hazards associated with the use of purchased liquefied chlorine and bulk sodium hypochlorite.

A direct current passed through a solution of sodium chloride (common salt) containing Na⁺ and Cl⁻, produces chlorine at the anode, and hydrogen at the cathode. With mixing of the catholyte, anolyte and sodium ions in the solution, sodium hypochlorite (Na⁺OCl⁻) was produced. The process had the advantage that the hypochlorite solution can be manufactured on site (if required), thus avoiding the risks of transporting, storing and handling liquid and gas chlorine and the difficulty of meeting all the associated safety measures required. A simple on-site generation system operation begins with usage of brine solution (3%).

The strength of hypochlorite obtained was found to be 0.5-0.7% using commercially available electrodes based on Titanium with energy requirement of 4-4.5 KW/hr.

The facilitated electro-chlorination process reduced the potential required for above reaction by using inorganic donor cum disinfectant like peroxide and hypochlorite.

The sodium hypochlorite solution of strength (1-14%) was thus produced in facilitated electro-chlorination process in presence of donor using the conventional electrolyzer. This generated a mixture of hypochlorite and other oxidants and is termed as hypochlorite based mixed oxidant solution.

The process developed was thus found relatively safe for on-site, generation of hypochlorite solution for disinfecting surfaces and is scalable ranging from 500 ml/h to 2 litre/h.

The donor assisted electro-chlorination hypochlorite generation was based on the usage of donor with potential to reduce electricity requirement and generate/add additional oxidant as the case maybe. It also had the potential of reduced energy footprint by facilitating electro chlorination with minimal energy input. The process had reduced environmental footprint i.e., reduced energy input with consequent minimal CO₂ emissions. The resultant hypochlorite solution admixed with in-situ generated oxidant or unused donor (as oxidant) or a by-product reaction (as oxidant) found application as disinfectant with significantly enhanced disinfection efficacy. The hypochlorite based mixed oxidant solution obtained by the facilitated electro-chlorination system using 3% brine was having higher disinfection potential compared to conventional hypochlorite and could be used as disinfectant. The strength of stable hypochlorite solution was found to be ranging from 1-7% for different donor systems illustrated.

### D) Integrated Standalone System for Solar Hydrogen and Oxygen Generation

i) Standalone Enhanced energy efficient Peltier based Functional PV panel coupled with energy efficient facilitated Water electrolyzer system using sacrificial/non-sacrificial donor (FIG. 3),
ii) Standalone Enhanced energy efficient functional PV panel with V-trough concentrator coupled with facilitated Water electrolyzer system using sacrificial/non-sacrificial donor (FIG. 3),
iii) Standalone Enhanced energy efficient functional PV panel with V-trough concentrator and peltier coupled with facilitated Water electrolyzer system using sacrificial/non-sacrificial donor),
iv) Unified, compact and modular system by Integration of Enhanced energy efficiency functional PV panel and non-sacrificial redox shuttle-based facilitated water electrolyzer (FIG. 6),
v) Unified system by Integration of Enhanced energy efficiency functional PV panel with sacrificial electrode-based water electrolyzer using sacrificial and non-sacrificial donor (FIG. 6),
vi) Unified, compact and modular system by Integration of energy efficient facilitated Water electrolyzer coupled with parabolic dish for harvesting &generating electricity by Peltier/TEG,
vii) Unified, compact and modular system by Integration of energy efficient facilitated Water electrolyzer (pyro-electric water splitting) coupled with peltier device for harvesting heat & generating electricity,
viii) Unified, compact and modular system by Integration of energy efficient facilitated photocatalyzed Water electrolyzer coupled with peltier device for harvesting heat & generating electricity,
ix) Unified, compact and modular system by Integration of energy efficient facilitated photocatalyzed Water electrolyzer coupled with photocatalyzed peltier device for harvesting heat & generating electricity,
x) Unified, compact and modular system by Integration of functional PV panel with retrofitted water electrolyzer (skirting type) using non-sacrificial donor and electrode,
xi) Unified, compact and modular system by Integration of functional PV panel with retrofitted water electrolyzer (bottom reactor with separator type).

### Example 2

The facilitated water electrolyzer generated solar hydrogen using donors. The system also generated sodium hypochlorite (in case of specific donors), that was widely used as a disinfectant. The steps involved are as follows:
a) The electrolytic solutions were prepared according to specific concentration for donors such as 3% NaCl, 1% H₂O₂, 3% NaCl+1% H₂O₂. The volume of electrolytic solutions (sacrificial & non-sacrificial) used during the experiments was 700 ml. The electrolytic solutions were further classified into three categories namely—neutral, acidic and alkaline.
b) The solution was filled in the water electrolyzer (acrylic reactor), up to a certain level. The electrodes were connected to the respective terminals (positive and WO 2023/181071 PCT/N2023/050276 negative) of the voltage regulator. The study was performed using Titanium electrodes (Mixed Metal Oxide coated) at 4 Volts at room temperature 32 to 36° C. The surface area of electrode was 380 cm².
c) A specific voltage was applied using the voltage regulator and the outlet of the water electrolyzer was connected to GC for analysis of hydrogen and oxygen generated.

Hydrogen generation rate using various donors and their combinations was studied and tabulated in table 1

TABLE 1
Effect of variation in NaCl & H₂O₂ concentration and pH on hydrogen generation

| | | | | | | H₂ | | O₂ | |
|---|---|---|---|---|---|---|---|---|---|
| Sl. | Electrolytic | | Voltage | Current | | (mmoles/ | H₂ | (mmoles/ | O₂ |
| no | Solution | Electrode | (Volts) | (Amperes) | pH | hr) | (lph) | hr) | (lph) |
| 1. | Water (H₂O) | Ti | 4 | 0.1 | 7 | 0.39 | 0.009 | 0.58 | 0.013 |
| 2. | 3% NaCl | Ti | 4 | 6.5 | 6.8 | 66.84 | 1.49 | 16.40 | 0.36 |
| 3. | 3% NaCl + | Ti | 3.5 | 11 | 1 | 84.50 | 1.89 | 22.90 | 0.51 |
| | 1N H₂SO₄ | | | | | | | | |
| 4. | 3% NaCl + | Ti | 4 | 12 | 13 | 215.01 | 4.8 | 96 | 2.15 |
| | 1N NaOH | | | | | | | | |
| 5. | 1% H₂O₂ | Ti | 4 | 0.05 | 6.5 | 0.01 | 0.0002 | 11.12 | 0.249 |
| 6. | 3% NaCl + | Ti | 4 | 11 | 6.7 | 146.14 | 3.27 | 62.20 | 1.39 |
| | 1% H₂O₂ | | | | | | | | |
| 7. | 3% NaCl+ | Ti | 3 | 12 | 1 | 165.30 | 3.70 | 48 | 1.07 |
| | 1% H₂O₂ + | | | | | | | | |
| | 1N H₂SO₄ | | | | | | | | |
| 8. | 3% NaCl + | Ti | 3.5 | 12 | 13 | 192 | 4.30 | 120.6 | 2.70 |
| | 1% H₂O₂ + | | | | | | | | |
| | 1N NaOH | | | | | | | | |

### Example 3

The study was performed using non-sacrificial electrode namely Titanium (Mixed Metal Oxide coated) electrode. All the steps were same as mentioned in the above examples. The concentration of H₂O₂ was constant and the study was conducted at varying concentrations of NaCl and subjected to electrolysis at 4 Volts. Hydrogen generation rates for the system is tabulated in table 2.

TABLE 2
Effect of variation in NaCl concentration on hydrogen generation

| | | | | | H₂ | | O₂ | |
|---|---|---|---|---|---|---|---|---|
| Sr. | Electrolytic | | Voltage | Current | (mmoles/ | H₂ | (mmoles/ | O₂ |
| No. | Solution | Electrode | (Volts) | (Amperes) | hr) | (lph) | hr) | (lph) |
| 1. | Water (H₂O) | Ti | 4 | 0.1 | 0.39 | 0.009 | 0.58 | 0.013 |
| 2. | 3% NaCl | Ti | 4 | 6.5 | 66.84 | 1.49 | 16.40 | 0.36 |
| 3. | 0.5% NaCl + | Ti | 4 | 5.5 | 57.63 | 1.29 | 19.70 | 0.441 |
| | 1% H₂O₂ | | | | | | | |
| 4. | 1% NaCl + | Ti | 4 | 6 | 104.38 | 2.33 | 30 | 0.67 |
| | 1% H₂O₂ | | | | | | | |
| 5. | 3% NaCl + | Ti | 4 | 11 | 146.14 | 3.27 | 62.20 | 1.39 |
| | 1% H₂O₂ | | | | | | | |
| 6. | 5% NaCl+ | Ti | 4 | 11.2 | 160.94 | 3.60 | 45.60 | 1.02 |
| | 1% H₂O₂ | | | | | | | |

### Example 4

Combination of NaCl and H₂O₂ was used as the electrolytic solution. The concentration of NaCl was constant and the study was conducted at varying concentrations of H₂O₂ subjected to 4V for electrolysis. The steps involved were same as that given in the above examples. Hydrogen generation rates for the system is tabulated in table 3.

TABLE 3
Effect of variation in H₂O₂ concentration on hydrogen generation

| | | | | | H₂ | | O₂ | |
|---|---|---|---|---|---|---|---|---|
| Sr | Electrolytic | | Voltage | Current | (mmoles/ | H₂ | (mmoles/ | O₂ |
| No. | Solution | Electrode | (Volts) | (Amperes) | hr) | (lph) | hr) | (lph) |
| 1. | Water (H₂O) | Ti | 4 | 0.1 | 0.39 | 0.009 | 0.58 | 0.013 |
| 2. | 3% NaCl | Ti | 4 | 6.5 | 66.84 | 1.49 | 16.40 | 0.36 |
| 3. | 3% NaCl + | Ti | 4 | 5.5 | 64.44 | 1.44 | 17.40 | 0.389 |
| | 0.1% H₂O₂ | | | | | | | |
| 4. | 3% NaCl + | Ti | 4 | 9 | 140.56 | 3.148 | 53.50 | 1.198 |
| | 0.5% H₂O₂ | | | | | | | |
| 5. | 3% NaCl + | Ti | 4 | 11 | 146.14 | 3.27 | 62.20 | 1.39 |
| | 1% H₂O₂ | | | | | | | |
| 6. | 3% NaCl + | Ti | 4 | 12.9 | 104.46 | 2.339 | 21.90 | 0.49 |
| | 3% H₂O₂ | | | | | | | |

### Example 5

This study was conducted at variation in voltage supply with respect to hydrogen generation for 3% NaCl and 3% NaCl+1% H₂O₂. The voltage was varied for the electrolytic solutions using voltage regulator. The study was carried out at 1, 2, 4 and 5 volts, using Ti electrodes (table 4). The steps involved were same as that given in the above examples.

TABLE 4
Effect of variation in voltage on hydrogen generation using NaCl and H₂O₂

| | | | | | H₂ | | O₂ | |
|---|---|---|---|---|---|---|---|---|
| Sr. | Electrolytic | | Voltage | Current | (mmoles/ | H₂ | (mmoles/ | O₂ |
| No. | Solution | Electrode | (Volts) | (Amperes) | hr) | (lph) | hr) | (lph) |
| 1. | Water (H₂O) | Ti | 4 | 0.1 | 0.39 | 0.009 | 0.58 | 0.013 |
| 2. | 3% NaCl | Ti | 1 | 0.12 | NA | NA | NA | NA |
| | | | 2 | 0.13 | 0.05 | 0.001 | 0.3 | 0.006 |
| | | | 4 | 6.5 | 66.84 | 1.49 | 16.40 | 0.36 |
| | | | 5 | 12 | 202.15 | 4.528 | 58.50 | 1.31 |
| 3. | 3% NaCl + | Ti | 1 | 0.11 | NA | NA | NA | NA |
| | 1% H₂O₂ | | 2 | 2.99 | 4.61 | 0.103 | 28.20 | 0.631 |
| | | | 4 | 11 | 146.14 | 3.27 | 62.20 | 1.39 |
| | | | 5 | 13.30 | 163.87 | 3.67 | 59..60 | 1.335 |

Oxygen enriched gas was obtained at higher concentration of peroxide (3% NaCl+5% H₂O₂) whereas at lower concentration of peroxide (3% NaCl+0.5% H₂O₂) hydrogen evolution was significantly enhanced.

### Example 6

This study was conducted for H₂O₂ as donor at different concentrations for hydrogen generation, at 4V using Ti electrodes (table 5). The steps involved were same as that given in the above examples.

TABLE 5
Hydrogen generation using H₂O₂ as donor

| | | | | | H₂ | | O₂ | |
|---|---|---|---|---|---|---|---|---|
| Sr | Electrolytic | | Voltage | Current | (mmoles/ | H₂ | (mmoles/ | O₂ |
| No. | Solution | Electrode | (Volts) | (Amperes) | hr) | (lph) | hr) | (lph) |
| 1. | 1N H₂SO₄ | Ti | 4 | 12.5 | 100.31 | 2.25 | 11.80 | 0.26 |
| 2. | 1% H₂O₂ | Ti | 4 | 0.1 | 0.004 | 0.0001 | 0.1 | 0.002 |
| 3. | 1N H₂SO₄ + | Ti | 4 | 13 | 153.70 | 3.44 | 27.80 | 0.62 |
| | 1% H₂O₂ | | | | | | | |
| 4. | 3% H₂O₂ | Ti | 4 | 0.1 | 0.004 | 0.0001 | 0.1 | 0.002 |
| 5. | 1N H₂SO₄ + | Ti | 4 | 12 | 126.49 | 2.83 | 13.90 | 0.31 |
| | 3% H₂O₂ | | | | | | | |

### Example 7

Similar study was mentioned in example 1 was conducted using non-sacrificial donors at 3 Volts and the electrodes used were Ti electrodes. The steps involved were same as mentioned in the above examples. HPA (Hetero Poly Acid) solutions analyzed for the respective hydrogen generation rates. The HPA used for experimentation was Phosphomolybdic acid (PMA). Hydrogen generation rates for the system is given in table 6.

TABLE 6
Hydrogen generation using non-sacrificial donors

| | | | | | H₂ | | O₂ | |
|---|---|---|---|---|---|---|---|---|
| Sr. | Electrolytic | | Voltage | Current | (mmoles/ | H₂ | (mmoles/ | O₂ |
| No. | Solution | Electrode | (Volts) | (Amperes) | hr) | (lph) | hr) | (lph) |
| 1) | Water (H₂O) | Ti | 3 | 0.5 | 0.39 | 0.009 | 0.58 | 0.013 |
| 2) | 1N H₂SO₄ | Ti | 3 | 8.3 | 105.73 | 2.368 | 41.6 | 0.931 |
| 3) | 1N H₂SO₄ + | Ti | 3 | 9 | 114.07 | 2.55 | 27.01 | 0.605 |
| | 0.002M HPB | | | | | | | |
| 4) | 3% NaCl + | | | | | | | |
| | 3% NaCl + | | 3 | 6.6 | 47.75 | 1.069 | 5.19 | 0.116 |
| | 1N H₂SO₄ + | Ti | | | | | | |
| | 0.002M HPB | | | | | | | |
| 5) | 3% NaCl + | Ti | 3 | 4.6 | 5.10 | 0.114 | 0.10 | 0.002 |
| | 1% H₂O₂ + | | | | | | | |
| | 0.002 HPB | | | | | | | |

### Example 8

The effect of alkaline electrolytic solutions on hydrogen generation for organic donors was studied. The electrode used was Titanium electrode. All the steps involved were same as given in examples above. Hydrogen generation rates for the system is tabulated in table 7.

TABLE 7
Hydrogen and Oxygen generation using organic donors

| | | | | | H₂ | | O₂ | |
|---|---|---|---|---|---|---|---|---|
| Sr. | Electrolytic | | Voltage | Current | (mmoles/ | H₂ | (mmoles/ | O₂ |
| No. | Solution | Electrode | (Volts) | (Amperes) | hr) | (lph) | hr) | (lph) |
| 1. | 0.5N NaOH | Ti | 4 | 11 | 149.09 | 3.34 | 62.60 | 1.40 |
| 2. | 0.5N NaOH + | Ti | 4 | 13 | 322.88 | 7.232 | 89.40 | 2.002 |
| | 5% Ethanol | | | | | | | |
| 3. | 0.5N NaOH + | Ti | 4 | 11 | 230.10 | 5.154 | 82.50 | 1.848 |
| | 5% Urea | | | | | | | |

### Example 9

Similar study was conducted using Sodium Borohydride (NaBH₄) as a donor at 3 Volts. The steps involved were same as mentioned in the above examples. 100 ppm NaBH₄ solution was prepared and analyzed for hydrogen generation using Titanium electrodes. Hydrogen generation rates for the system is tabulated in table 8.

TABLE 8
Hydrogen generation using Sodium Borohydride (NaBH₄) as a donor

| | | | | | H₂ | | O₂ | |
|---|---|---|---|---|---|---|---|---|
| Sr. | Electrolytic | | Voltage | Current | (mmoles/ | H₂ | (mmoles/ | O₂ |
| No. | Solution | Electrode | (Volts) | (Amperes) | hr) | (lph) | hr) | (lph) |
| 1. | Water | Ti | 3 | 0.5 | 0.39 | 0.009 | 0.58 | 0.013 |
| 2. | 100 ppm | Ti | 0 | 0 | 0.32 | 0.007 | — | — |
| | NaBH₄ | | | | | | | |
| 3. | 100 ppm | Ti | 3 | 0.75 | 7.76 | 0.174 | 4.47 | 0.100 |
| | NaBH₄ | | | | | | | |

### Example 10

A combination of NaOH and CO₂ was studied for generation of hydrogen. CO₂ gas was bubbled through NaOH solution at 0.25 to 0.5 lpm. The electrolytic solution was subjected to electrolysis at 4 Volts using Titanium electrodes. The hydrogen generation data for the solution is tabulated in table 9.

TABLE 9
Hydrogen generation using Sodium Hydroxide + Carbon Dioxide (NaOH + CO₂)

| | | | | | H₂ | | O₂ | |
|---|---|---|---|---|---|---|---|---|
| Sr. | Electrolytic | | Voltage | Current | (mmoles/ | H₂ | (mmoles/ | O₂ |
| No. | Solution | Electrode | (Volts) | (Amperes) | hr) | (lph) | hr) | (lph) |
| 1. | 0.2N NaOH + | Ti | 4 | 6.4 to 6.9 | 95.56 | 2.14 | 43.69 | 0.978 |
| | CO₂ | | | | | | | |
| 2. | 0.4N NaOH + | Ti | 4 | 5.4 to 6.3 | 93.66 | 2.09 | 45.93 | 1.028 |
| | CO₂ | | | | | | | |
| 3. | 0.6N NaOH + | Ti | 4 | 6.5 to 7.2 | 91.80 | 2.05 | 42.72 | 0.956 |
| | CO₂ | | | | | | | |
| 4. | 1N NaOH + | Ti | 4 | 10.5 | 155.74 | 3.488 | 65.61 | 1.469 |
| | CO₂ | | | | | | | |
| 5. | 1N NaOH | Ti | 4 | 10 to 12 | 114.84 | 3.244 | 50.88 | 1.139 |

### Example 11

Sewage samples were collected from open drain and experiments were performed at 4 V for hydrogen generation with different donors and the results are tabulated in the following table 10.

TABLE 10
Hydrogen generation using Sewage water

| | | | | | H₂ | | O₂ | |
|---|---|---|---|---|---|---|---|---|
| Sr. | Electrolytic | | Voltage | Current | (mmoles/ | H₂ | (mmoles/ | O₂ |
| No. | Solution | Electrode | (Volts) | (Amperes) | hr) | (lph) | hr) | (lph) |
| 1. | Sewage water | Ti | 4 | 0.6 | 0.939 | 0.02 | 0.777 | 0.017 |
| 2. | Sewage water + | Ti | 4 | 1.01 | 17.81 | 0.40 | 4.64 | 0.104 |
| | 0.002M HPA | | | | | | | |

### Example 12

Same study was conducted using Potassium Permanganate (KMnO₄) as a donor at 4 Volts. The steps involved were same as mentioned in the above examples. Neutral KMnO₄ (0.5% KMnO₄), alkaline KMnO₄ (0.1N NaOH+0.5% KMnO₄) and the combination of 3% NaCl and 0.5% KMnO₄ solutions were prepared and analyzed for the respective hydrogen and oxygen generation and the results are tabulated in the following table 11.

TABLE 11
Hydrogen and Oxygen generation using KMnO₄ as a donor

| | | | | | H₂ | | O₂ | |
|---|---|---|---|---|---|---|---|---|
| Sr. | Electrolytic | | Voltage | Current | (mmoles/ | H₂ | (mmoles/ | O₂ |
| No. | Solution | Electrode | (Volts) | (Amperes) | hr) | (lph) | hr) | (lph) |
| 1. | 0.5% KMnO₄ | Ti | 4 | 1.46 | 9.45 | 0.21 | 12.25 | 0.28 |
| 2. | 3% NaCl + | Ti | 4 | 7.4 | 102.15 | 2.28 | 29.90 | 0.67 |
| | 0.5% KMnO₄ | | | | | | | |
| 3. | 0.1N NaOH + | Ti | 4 | 2.26 | 36.72 | 0.822 | 19.20 | 0.43 |
| | 0.5% KMnO₄ | | | | | | | |

### Example 13

The study was conducted using sacrificial (Aluminium) and non-sacrificial (Titanium) electrodes with variable voltage such as, 0.5V, 1V, 1.5V, 3V. The steps involved were same as mentioned in the above examples. 1 M Na₂S solution (13%) was prepared and analysed for the respective hydrogen generation using both the electrodes and the results are tabulated in the following table 12

TABLE 12
Hydrogen generation using Sodium Sulphide (Na₂S)

| | | | | | H₂ | | O₂ | |
|---|---|---|---|---|---|---|---|---|
| Sr. | Electrolytic | | Voltage | Current | (mmoles/ | H₂ | (mmoles/ | O₂ |
| No. | Solution | Electrode | (Volts) | (Amperes) | hr) | (lph) | hr) | (lph) |
| 1. | 1M Na₂S | Al—Ti | 0.5 | 1 | 133.90 | 3 | Nil | Nil |
| 2. | 1M Na₂S | Al—Ti | 1 | 5.7 | 223.20 | 5 | Nil | Nil |
| 3. | 1M Na₂S | Al—Ti | 1.5 | 7.5 | 312.50 | 7 | Nil | Nil |
| 4. | 1M Na₂S | Al—Ti | 3 | 10-12 | 558.03 | 12.5 | Nil | Nil |

### Example 14

The study was conducted using sacrificial (Aluminium) and non-sacrificial (Titanium) electrodes with variable concentration of Na₂S such as, 0.5M, 1M, 2M at 1V. The steps involved were same as mentioned in the above examples and the results are tabulated in the following table 13.

TABLE 13
Hydrogen generation using Sodium Sulphide (Na₂S) with different conc.

| | | | | | H₂ | | O₂ | |
|---|---|---|---|---|---|---|---|---|
| Sr. | Electrolytic | | Voltage | Current | (mmoles/ | H₂ | (mmoles/ | O₂ |
| No. | Solution | Electrode | (Volts) | (Amperes) | hr) | (lph) | hr) | (lph) |
| 1. | 0.5M Na₂S | Al—Ti | 1 | 3 | 133.9 | 3 | Nil | Nil |
| 2. | 1M Na₂S | Al—Ti | 1 | 5.5 | 223.2 | 5 | Nil | Nil |
| 3. | 2M Na₂S | Al—Ti | 1 | 5 | 357.14 | 8 | Nil | Nil |

### Example 15

The concentration of donor (H₂O₂) was varied for the study of resultant hypochlorite concentration at the same voltage (5 V) for specific time duration (30 minutes) and the results are tabulated in the following table 14.

TABLE 14
Hypochlorite generation using various donors

% NaOCl

| | | | 3% NaCl + | 3% NaCl + |
|---|---|---|---|---|
| Sr. | Time | 3% NaCl | 1% NaClO4 | 1% H₂O₂ |
| No. | (minutes) | (5 V) | (5 V) | (5 V) |
| 1. | 0 | 0 | 1.034 | 2.53 |
| | (Blank) | | | |
| 2. | 15 | 0.112 | 0.997 | 2.865 |
| 3. | 30 | 0.201 | 0.990 | 2.389 |

### Example 16

The variation in hypochlorite concentration using 1% H₂O₂ as donor was studied at different voltages ranging from 1-5 Volts. The results are tabulated in the following table 15.

TABLE 15
Hypochlorite generation at varied H₂O₂ concentrations

% NaOCl

| Sr. | Time | | 3% NaCl + | 3% NaCl + |
|---|---|---|---|---|
| No. | (minutes) | 3% NaCl | 1% H₂O₂ | 5% H₂O₂ |
| 1. | 0 | 0 | 2.53 | 14.366 |
| | (Blank) | | | |
| 2. | 15 | 0.112 | 2.865 | 12.617 |
| 3. | 30 | 0.201 | 2.389 | 12.729 |

The electrolysis of 3% NaCl+1% H₂O₂ solution at 5V concomitantly generated Oxygen as a by-product at an approximate rate of 0.12 mmoles/hr-cm² of electrode.

### Example 17

The stability of the hypochlorite solution generated using different concentrations of H₂O₂ at the same voltage was studied after one and three days. The mixed oxidant solution was found to be considerably stable for 1% H₂O₂ as donor at 1 V.

The stability data is tabulated in the following table 16.

TABLE 16
Effect of Voltage variation on hypochlorite generation

| | | % NaOCl | | |
|---|---|---|---|---|
| | | 3% NaCl + | 3% NaCl + | 3% NaCl + |
| Sr. | Time | 1% H₂O₂ | 1% H₂O₂ | 1% H₂O₂ |
| No. | (minutes) | (1 V) | (3 V) | (5 V) |
| 1. | 0 | 2.65 | 2.687 | 2.53 |
| | (Blank) | | | |
| 2. | 15 | 2.865 | 2.865 | 2.865 |
| 3. | 30 | 2.925 | 2.761 | 2.389 |

### Example 18

The stability of the hypochlorite solution generated using different concentrations of H₂O₂ at the same voltage was studied after one and three days. The mixed oxidant solution was found to be considerably stable for 1% H₂O₂ as donor at 1 V.

The stability data is tabulated in the following table 17.

TABLE 17
Hypochlorite stability data studied for various concentrations

% NaOCl

| | | 3% NaCl + | 3% NaCl + |
|---|---|---|---|
| Sr. | | 1% H₂O₂ | 5% H₂O₂ |
| No. | Time | (1 V) | (1 V) |
| 1. | 0 | 2.65 | 15.660 |
| | (Blank) | | |
| 2. | 15 minutes | 2.865 | 15.930 |
| 3. | 30 minutes | 2.925 | 18.088 |
| 4. | Day 1 | 2.977 | 13.624 |
| 5. | Day 3 | 2.545 | 12.989 |

### Example 19

The study was performed using non-sacrificial electrode namely Titanium (Mixed Metal Oxide coated) electrode by using the photo-illumination effect (tungsten lamp) which helps to accelerate the reaction mechanism. The experiment was performed at 2V and 2 to 2.5 A with 3% NaCl and 1% H₂O₂. (Table 18).

TABLE 18
Effect of photo-illumination on hydrogen generation

| | | | | | H₂ | | O₂ | |
|---|---|---|---|---|---|---|---|---|
| Sr. | Electrolytic | | Voltage | Current | (mmoles/ | H₂ | (mmoles/ | O₂ |
| No. | Solution | Electrode | (Volts) | (Amperes) | hr) | (lph) | hr) | (lph) |
| 1. | *3% NaCl + | Ti | 0 | 0 | 3.17 | 0.071 | 39.76 | 0.89 |
| | 1% H₂O₂ | | | | | | | |
| 2. | *3% NaCl + | Ti | 2 | 2.5 | 9.05 | 0.202 | 54.04 | 1.21 |
| | 1% H₂O₂ | | | | | | | |
| 3. | 3% NaCl + | Ti | 2 | 2.9 | 4.61 | 0.103 | 28.2 | 0.631 |
| | 1% H₂O₂ | | | | | | | |

*With tungsten bulb illumination

### Example 20

The study was performed on the functional PV-panel which was retrofitted with V-trough glass reflectors and heat harvesting device (peltier device) with hydrophobic coating of PMMA on the surface of panel, which enhanced the shelf-life of the PV-panel with enhanced electrical efficiency of 6-8% over commercial panel. The results for the system are tabulated in table 19. % Enhancement in electrical output of F-PV designs over the Commercial PV-panel are as follows, % Enhancement in electrical output of PV-panel with V-trough reflectors=4-5%, % Enhancement in electrical output of PV-panel with V-trough reflectors and peltier device=4-5%, % Enhancement in electrical output of PV-panel with V-trough reflectors and peltier device with cooling i.e., FUNCTIONAL PV-PANEL=6-8%

TABLE 19
Power enhancement of functional PV-panel over the commercial PV-panel
Power output (W)

| | | | PV panel with V- | |
|---|---|---|---|---|
| | | PV panel with | Trough and Peltier | % Enhancement |
| Commercial | PV panel with | V-Trough and | system with cooling | over Commercial |
| PV-panel | V-Trough | Peltier system | (Functional PV-panel) | PV-panel |
| 48.95 | 51.46 | 53.22 | 55.75 | 6.8% |
| 54.91 | 58.73 | 59.16 | 62.87 | 7.96% |
| 60.53 | 64.15 | 66.58 | 69.74 | 9.22% |
| 52.98 | 54.83 | 53.27 | 60.60 | 7.70% |
| 43.58 | 46.34 | 48.34 | 49.25 | 5.75% |

### ADVANTAGES OF INVENTION

Functional (photovoltaic) PV panel provides enhancement in electrical efficiency with improved shelf life and stability of solar panel and thus reduces the CAPEX and OPEX and exploits unused photons of UV and IR & by harvesting heat through Peltier device & nano fluids.

Hybridization of water electrolyzer with innovations of photocatalysis & plasmonic enhances H₂ evolution rate with consequent decrease in OPEX. The usage of inorganic and organic donors enhances H₂ evolution rate with consequent decrease on OPEX.

Integrated system is hybrid, modular, portable & transformative for delivering hydrogen gas and thus reduces the CAPEX and OPEX.

1. A functional (photovoltaic) PV power facilitated water electrolyzer system for solar hydrogen generation, wherein the said system comprises:
i. a functional solar PV Panel (2), and
ii. a facilitated water electrolyzer (3),
wherein the functional solar PV panel (2) is made of reflectors (1) and a heat harvesting system with a hydrophobic coating on the PV panel with enhanced efficiency of 6-8% over commercial panel.

2. The functional PV power facilitated water electrolyzer system as claimed in claim 1, wherein the system includes standalone and integrated system with non-sacrificial electrodes with or without sacrificial anode with enhancement efficiency by a factor of 1.2-1.5 for hydrogen evolution reaction (HER) and reduced footprint.

3. The functional PV power facilitated water electrolyzer system as claimed in claim 1, wherein an electrolysis chamber of the functional PV (85 cm×80 cm×12 cm) powered facilitated water electrolyzer system (42 cm×55 cm×6 cm) is retrofitted with a photo-illumination effect through tungsten bulb using two anodic plates of titanium electrode coated with a mixed metal oxide and three uncoated cathodic plates water electrolysis to generate hydrogen at the cathode, oxygen at the anode and hypochlorite in the solution and the system is standalone comprising of the following components,
i. reflectors (1) (85 cm×80 cm) retrofitted to solar PV panel with the photonic wavelength to enhance the electric output of PV panel,
ii. functional solar PV panel (2) (85 cm×80 cm) with increased electrical output to operate the facilitated water electrolyzer,
iii. facilitated water electrolyzer (3) (42 cm×55 cm×6 cm) with enhanced water electrolysis rate, and comprises components (4-12),
iv. solution inlet (4) with tungsten lamp fixed inside the chamber (2 cm diameter) is to introduce the electrolytic solution inside the chamber whereas the retrofitted tungsten lamp is for photo-illumination effect,
v. solution level indicator (5) 4 cm×3.5 cm to check the solution level inside the electrolysis chamber to ensure the dipping of Ti electrode,
vi. reactor chamber (6) 23 cm×30 cm×22 cm to carry out PV-based water electrolysis reaction inside the chamber,
vii. hydrogen outlet (7) of 3 cm diameter to collect the hydrogen gas,
viii. Ti electrode (8) made of mixed metal oxide coated with surface area of 300 cm² and provides surface for redox reactions at cathode and anode for hydrogen and oxygen evolution reactions,
ix. On/Off Switch (9) 2 cm×4.5 cm to start/stop the water electrolysis reaction,
x. Cooling fan (10) 13 cm×13 cm to maintain the temperature of electric circuit,
xi. Voltmeter (11) is 7 cm×7 cm for display the DC voltage supplied for water electrolysis,
xii. Ammeter (12) is 7 cm×7 cm for display of DC current supplied for water electrolysis, and
xiii. facilitated water electrolyzer (3) with electrolytic solution and retrofitted with photo-illumination effect through tungsten bulb using two plates of titanium electrode coated with mixed metal oxide.

4. The functional PV power facilitated water electrolyzer system as claimed in claim 1, wherein the facilitated water electrolyzer of dimension 85 cm×80 cm×12 cm is retrofitted behind the functional PV panel (85 cm×80 cm×12 cm) for integrated and compact system having electrolytic solution and two plates of titanium electrode coated with mixed metal oxide subjected to water electrolysis to generate hydrogen at the cathode, oxygen at the anode and hypochlorite in the solution and the system also comprises components (1), (2), (4), (5), (7), (8), (9), (11) and (12).

5. A method of solar hydrogen generation with functional PV power facilitated water electrolyzer system as claimed in claim 1, wherein the method comprises the steps of:
i. preparing sacrificial & non-sacrificial electrolytic solutions as donors wherein the electro-catalytic solution is having pH in the range of 5.0-6.0, 7.0-7.2 and 9.0-12.0,
ii. filling the electrolytic solutions obtained of step (i) in facilitated water electrolyzer up to 8 L/12 L reactor volume,
iii. connecting the electrodes to terminals (positive and negative) of the voltage regulator and applying a voltage in the range of 3 to 4 Volts at temperature in the range of 32 to 36° C. with or without illumination to produce hydrogen (2-42 lph), oxygen (0-12.6 lph) and sodium hypochlorite (stable range of 0-13%) is produced as a by-product.

6. The method of solar hydrogen generation with functional PV power facilitated water electrolyzer system as claimed in claim 5, wherein the donor is selected from NaCl, hydrogen peroxide, 3% NaCl+1% H₂O₂, Potassium Permanganate (KMnO₄), Sodium sulphide, Sodium Borohydride (NaBH₄), heteropoly acids, ethanol, urea, or combinations thereof.

7. The method of solar hydrogen generation with functional PV powered water electrolyzer system as claimed in claim 5, wherein the electrodes (anodes and cathodes) are sacrificial or non-sacrificial, selected from titanium, aluminium, steel, or nickel electrodes with and without mixed metal oxide coating.

8. The method of solar hydrogen generation with functional PV powered water electrolyzer system as claimed in claim 5, wherein the non-sacrificial electrodes are titanium electrodes with mixed metal oxide coating selected from ruthenium and iridium salt; and the sacrificial electrodes are aluminium electrodes (anode) and the surface area of the electrode is at least 360 cm².

9. The method of solar hydrogen generation with functional PV powered water electrolyzer (without illumination) system as claimed in claim 5, wherein the method generates hydrogen (2-42 lph) with an electrolyte volume of 1 litre to 25 litre, oxygen (0-12.6 lph) and sodium hypochlorite (stable range of 0-13%) using non sacrificial Ti mixed metal oxide coated electrodes, 0-30% NaCl and 0-1% H₂O₂ as donor; sacrificial anode (steel) & non sacrificial Ti mixed metal coated cathode using 0-3% NaCl as donor; and sacrificial anode (aluminium) and non-sacrificial Ti mixed metal coated cathode using Na₂S as donor, the variation in the volume of the electrolyte to volume of the reactor is between 8-12 L to 35-40 L and on illumination hydrogen evolution rate (HER) enhances by a factor of 1.5-2.0 with all other conditions and parametric ranges remaining the same.
